(19) United States
(12) Patent Application Publication
(10) Pub. No.: US 2025/0063425 A1
(43) Pub. Date: Feb. 20, 2025

(54) Electronic Devices with Wireless Data Rate Impairment Mitigation

(71) Applicant: Apple Inc., Cupertino, CA (US)

(72) Inventors: Vishwanth Kamala Govindaraju, Mountain View, CA (US); Sriram Subramanian, San Jose, CA (US); Alosious Pradeep Prabhakar, Singapore (SG); Vijendrakumar K Ashiwal, San Jose, CA (US); Vijay Venkataraman, San Jose, CA (US); Shiva Krishna Narra, Dublin, CA (US); Sanjeevi Balasubramanian, San Jose, CA (US)

(21) Appl. No.: 18/771,113

(22) Filed: Jul. 12, 2024

Related U.S. Application Data
(60) Provisional application No. 63/520,324, filed on Aug. 17, 2023.

(51) Int. Cl. H04W 28/02

(52) U.S. Cl. CPC H04W 28/0273

(57) ABSTRACT

A cellular communications system may include a user equipment (UE) that executes a target and non-target applications. The UE may convey a first stream of non-quality-of-service (QoS) wireless data with a first external device over a first Transmission Control Protocol (TCP) session and may receive a second stream of non-QoS wireless data from a second external device over a second TCP session. Responsive to a drop in data rate of the first stream, the UE may perform mitigation operations that adjust receipt of the second stream to boost the data rate of the first stream. The mitigation operations may include transmission of a triple duplicate acknowledgement (TDA), delayed transmission of an acknowledgment (ACK) to the second stream, and/or terminating the second TCP session. This may prevent disruptions to user experience with the first software application even when the network has downlink data to transmit to the UE.

This application claims the benefit of U.S. Provisional Patent Application No. 63/520,324, filed Aug. 17, 2023, which is hereby incorporated by reference herein in its entirety.

### FIELD

This disclosure relates generally to wireless communications, including wireless communications performed by user equipment devices.

### BACKGROUND

Communications systems can include a user equipment device that conveys wireless data with a cellular network. The wireless data can include wireless data for multiple software applications executed at the user equipment device.

Some software applications have higher wireless data rate requirements than other software applications. If care is not taken, conveying wireless data for software applications with lower data rate requirements undesirably impairs the data rate for software applications having higher data rate requirements, which can deteriorate user experience.

### SUMMARY

A communications system may include a user equipment (UE) device that communicates with a base station of a cellular network. The UE device may execute multiple software applications. The software application may include at least a target application and a non-target application that is less latency sensitive than the target application. The UE device may include a radio that conveys a first stream of non-quality-of-service (QoS) wireless data with a first external device over a first Transmission Control Protocol (TCP) session via the base station. The radio may concurrently receive a second stream of non-QoS wireless data from a second external device over a second TCP session via the base station.

In response to a trigger condition, processing circuitry on the UE device may perform one or more data rate impairment mitigation operations that adjust receipt of the second stream of wireless data to boost a data rate of the first stream of wireless data. The trigger condition may be reduction of the actual or predicted data rate of the first stream of wireless data below a threshold, an excessively low or excessively high inter-packet arrival time of the first stream of wireless data, an excessive round trip time (RTT) of the first stream of wireless data, and/or an excessive video stall percentage of the first software application, as examples. The predicted data rate may be the lower of a theoretical data rate and a statistical data rate associated with usage of the first software application in a cell of the base station.

The mitigation operations may include transmission of a triple duplicate acknowledgement (TDA) to a packet in the second stream of wireless data. This may cause the second external device to reduce a congestion window associated with the second stream of wireless data. Additionally or alternatively, the mitigation operations may include delaying transmission of an acknowledgment (ACK) to a packet in the second stream of wireless data beyond a scheduled time for transmission of the ACK. Additionally or alternatively, the mitigation operations may include ending the second TCP session. Each of these mitigation operations may effectively reduce the data rate of the second stream of wireless data while boosting the data rate of the first stream of wireless data to prevent disruptions to user experience with the first software application, even when the network has downlink data for the second software application to be transmitted to the UE device.

An aspect of the disclosure provides a method of operating an electronic device to communicate with at least a first external device and a second external device via a base station of a cellular network. The method can include executing, using processing circuitry, a first software application and a second software application that is less latency-sensitive than the first software application. The method can include conveying, using one or more antennas, a first stream of wireless data with the first external device via the base station, the first stream of wireless data being associated with the first software application. The method can include receiving, using the one or more antennas, a second stream of wireless data from the second external device via the base station, the second stream of wireless data being associated with the second software application. The method can include adjusting, using the processing circuitry, receipt of the second stream of wireless data responsive to a data rate of the first stream of wireless data being less than a threshold value.

An aspect of the disclosure provides an electronic device configured to communicate via a wireless network. The electronic device can include processing circuitry configured to execute a first software application and a second software application. The electronic device can include one or more antennas. The electronic device can include a radio communicably coupled to the one or more antennas. The radio can be configured to convey, using the one or more antennas, a first stream of wireless data for the first software application over a first transmission control protocol (TCP) session. The radio can be configured to receive, using the one or more antennas, a second stream of wireless data for the second software application over a second TCP session. The radio can be configured to transmit, using the one or more antennas, a triple duplicate acknowledgement (TDA) to a packet of the second stream of wireless data based on a data rate of the first wireless data.

An aspect of the disclosure provides a method of operating an electronic device to communicate with at least a first external device and a second external device via a cellular network. The method can include conveying, using a radio, a first stream of wireless data with the first external device in a first transmission control protocol (TCP) session. The method can include receiving, using the radio, a second stream of wireless data from the second external device in a second TCP session. The method can include when a performance metric of the first stream of wireless data is outside a predetermined range, delaying transmission of a TCP acknowledgment (ACK) packet in the second TCP session beyond a scheduled transmission time of the TCP ACK packet.

### BRIEF DESCRIPTION OF THE DRAWINGS

FIG. 1 is a diagram of an illustrative communications system having a user equipment device that communicates with a cellular network in accordance with some embodiments.

FIG. 2 is a schematic block diagram of an illustrative user equipment device in accordance with some embodiments.

FIG. 3 is a diagram of illustrative storage circuitry on a user equipment device that stores multiple software applications each having associated wireless data that is conveyed by the user equipment device in accordance with some embodiments.

FIG. 4 is a plot showing how receiving wireless data for a non-target software application executed by a user equipment device can undesirably impair the data rate of a target software application executed by the user equipment device in accordance with some embodiments.

FIG. 5 is a timing diagram showing how receiving wireless data for a non-target software application executed by a user equipment device can affect the inter-arrival time of wireless data packets for a target software application executed by the user equipment device in accordance with some embodiments.

FIG. 6 shows a flow chart of illustrative operations performed by a device to mitigate data rate impairment for a target software application, in accordance with some embodiments.

FIG. 7 show a flow chart of illustrative operations performed by a device to mitigate data rate impairment for a target software application, in accordance with some embodiments.

FIG. 8 is a flow chart of illustrative operations involved in mitigating data rate impairment of a target software application, in accordance with some embodiments.

FIG. 9 is a timing diagram showing how an illustrative user equipment device may transmit a triple duplicate acknowledgement to wireless data received for a non-target software application for mitigating data rate impairment of a target software application in accordance with some embodiments.

FIG. 10 is a timing diagram showing how an illustrative user equipment device may end a TCP session for a non-target software application to mitigate data rate impairment of a target software application in accordance with some embodiments.

FIG. 11 is a flow chart of illustrative operations involved in mitigating data rate impairment of a target software application by instructing a source device to reduce data transfer for the target software application when the target software application is executed in the background on a user equipment device in accordance with some embodiments.

FIG. 12 is a plot showing how the mitigation operations of FIGS. 6-11 serve to maximize the wireless data rate of a target software application in accordance with some embodiments.

### DETAILED DESCRIPTION

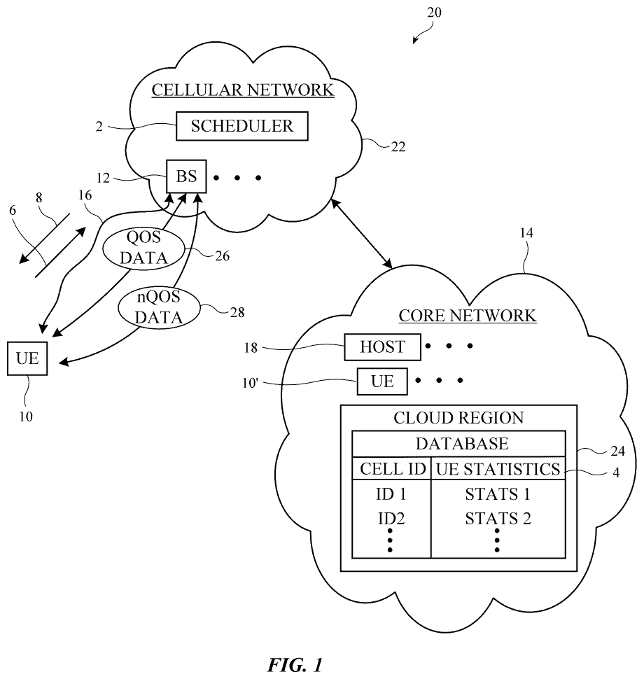

FIG. 1 is a diagram of an illustrative communications system 20. Communications system 20 (sometimes referred to herein as communications network 20, network 20, or system 20) includes a user equipment (UE) device 10 that communicates with a wireless network such as cellular network 22 (e.g., a cellular telephone network). Communications system 20 also includes a core network 14. Core network 14 is communicably coupled to cellular network 22 over one or more wired and/or wireless links.

In general, cellular network 22 and core network 14 may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, radio-frequency cables such as coaxial cables or other transmission lines, etc.). The wireless links may include short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles.

The nodes of cellular network 22 and/or core network 14 may be organized into one or more relay networks, mesh networks, local area networks (LANs), wireless local area networks (WLANs), ring networks (e.g., optical rings), cloud networks, virtual/logical networks, the Internet (e.g., may be communicably coupled to each other over the Internet), combinations of these, and/or using any other desired network topologies. The network nodes, terminals, and/or end hosts of cellular network 22 and/or core network 14 may include network switches, network routers, optical add-drop multiplexers, other multiplexers, repeaters, modems, portals, gateways, servers, network cards (line cards), wireless access points, wireless base stations, and/or any other desired network components. The network nodes in cellular network 22 and/or core network 14 may include physical components such as electronic devices, servers, computers, network racks, line cards, user equipment, etc., and/or may include virtual components that are logically defined in software and that are distributed across (over) two or more underlying physical devices (e.g., in a cloud network configuration).

Cellular network 22 may include one or more wireless base stations such as base station (BS) 12 (e.g., a gNB). UE device 10 may wirelessly communicate with base station 12 using a wireless communications link. UE device 10 may convey radio-frequency signals 16 with base station 12 to support the wireless communications link. Radio-frequency signals 16 may be conveyed in uplink (UL) direction 8 from UE device 10 to base station 12 and/or in downlink (DL) direction 6 from base station 12 to UE device 10. If desired, UE device 10 may wirelessly communicate with base station 12 without passing communications through any other intervening network nodes in communications system 20 (e.g., UE device 10 may communicate directly with base station 12 over-the-air). If desired, UE device 10 may concurrently communicate with multiple base stations 12 of cellular network 22 (e.g., under a carrier aggregation (CA) scheme).

Each base station 12 in cellular network 22 may include one or more antennas. An antenna may include two or more antenna elements such as a phased antenna array. The one or more antennas may provide wireless coverage for UE devices located within a corresponding geographic area or region, sometimes referred to as the coverage area, service area, or cell of the corresponding base station. Each base station 12 may have a respective cell in cellular network 22 that covers a corresponding geographic area and each base station 12 may communicate with UE devices located within its cell.

Each cell of cellular network 22 may have any desired shape (e.g., a circular shape, a hexagonal shape, etc.) and may cover any desired area. In general, the size of a cell may correspond to the maximum transmit power level of its base station 12 and the over-the-air attenuation characteristics for radio-frequency signals conveyed by that base station 12, for example. The cells of cellular network 22 may be distributed over one or more geographic regions, areas, or locations such as one or more buildings, campuses, cities, counties, provinces, states, countries, or continents.

When a UE device is located within a given cell, the UE device may connect with the base station 12 (sometimes referred to herein as attaching to base station 12) of that cell and may then communicate with the base station over a wireless link (e.g., using radio-frequency signals 16). To support the wireless link, base station 12 may transmit radio-frequency signals 16 in DL direction 6, sometimes referred to herein as DL signals, and/or the UE device may transmit radio-frequency signals 16 in UL direction 8, sometimes referred to herein as UL signals (e.g., the wireless link may be a bidirectional link).

Cellular network 22 may be operated, controlled, serviced, and/or administered by a corresponding cellular network operator or cellular service provider. Each UE device of cellular network 22 (e.g., UE devices registered with cellular network 22) may, for example, include a subscriber identity module (SIM) associated with cellular network 22 and/or the cellular network operator of cellular network 22. Cellular network 22 and the corresponding cellular network operator may sometimes be referred to herein collectively as “the network.”

The cellular network operator may use one or more schedulers such as scheduler 2 to generate, store, maintain, update, and/or implement one or more communications schedules for the UE devices that communicate with the base stations of cellular network 22 (e.g., UE devices registered with cellular network 22). The communications schedule identifies the communications resources (e.g., frequency resources, timing resources, radio access technology (RAT) resources, data modulation/encoding resources, etc.) used to convey wireless data to and/or from each of the UE devices of cellular network 22 (e.g., in a manner that balances traffic loads across the resources of cellular network 22 while minimizing interference between the UE devices). Scheduler 2 may be stored on storage circuitry on one or more base stations 12 and/or other nodes of cellular network 22. Scheduler 2 may be implemented/executed using one or more processors located on one or more base stations 12, on one or more other nodes of cellular network 22, and/or distributed across two or more nodes of cellular network 22.

UE device 10 may convey wireless data with another node of communications system 20 via base station 12. For example, UE device 10 may transmit wireless data (e.g., UL data) to base station 12 (using radio-frequency signals 16) for forwarding to an end host of cellular network 22 and/or core network 14 (e.g., a given host 18 of core network 14 and/or another UE device such as UE device 10′). Additionally or alternatively, base station 12 may receive wireless data from an end host of cellular network 22 and/or core network 14 (e.g., a given host 18 of core network 14 and/or another UE device such as UE device 10′) for forwarding to UE device 10 (e.g., as DL data in radio-frequency signals 16).

Host 18 may, for example, include one or more servers of a content delivery network (CDN) that serves wireless content (e.g., application data, streaming audio data, streaming video data, email messages, text messages, notifications, emergency messages, internet data, image data, operating system data, etc.) to UE device 10 via cellular network 22. Additionally or alternatively, host 18 may include one or more message or data forwarding servers (e.g., of a corresponding cloud region) that relay or forward wireless data between UE device 10 and another UE device such as UE device 10′. In general, host 18 may be any desired source and/or destination of wireless data conveyed by UE device 10. UE device 10′ may be similar to UE device 10 and may convey, for example, streaming video data (e.g., a video call), streaming audio data (e.g., a voice call or audio of a video call), text messages, email messages, or other application data with UE device 10 via cellular network 22. While UE device 10′ is shown in FIG. 1 as a part of core network 14 for the sake of simplicity, UE device 10′ may convey radio-frequency signals with a corresponding BS of cellular network 22 if desired (e.g., in situations where both UE device 10′ and UE device 10 are registered to and communicate with the same cellular network 22).

If desired, core network 14 may include a cloud region 24 associated with UE device 10. Cloud region 24 may, for example, be associated with the operating system of UE device 10. Cloud region 24 may store a database 4. Database 4 may store UE statistics associated with each cell (e.g., each base station 12) of cellular network 22. For example, the entries of database 4 may include a corresponding cellular identifier (e.g., ID1, ID2, etc.) that identifies a corresponding base station 12 and corresponding UE statistics (STATS1, STATS2, etc.) gathered by UE devices while communicating with that base station 12. The cellular identifiers may, for example, be unique global cell identifiers (GCIs). The UE statistics may include historical statistics identifying one or more wireless parameters and/or the wireless performance of the corresponding base station over time. For example, the UE statistics may include information identifying the theoretical data rate supported by each cell or base station, the average user equipment data rate for different software applications in each cell, the average latency experienced for different software applications in each cell, the NR bandwidth configured for users in each cell, data rate information, bandwidth information, radio access technology information, wireless performance metric data information, and/or any other desired parameters associated with or supported by the base station. The UE statistics may be gathered by UE devices while communicating with the corresponding base station 12. The UE devices may transmit the UE statistics to cloud region 24 for storage and/or compilation at database 4. Cloud region 24 may provide one or more entries of database 4 to UE device 10 for the UE device to use in communicating via cellular network 22.

UE device 10 may store and execute multiple software applications that require the transmission and/or reception of wireless data with host 18 or UE device 10′. The software applications can include a quality-of-service (QoS) application that conveys QoS data 26 with UE device 10′ via a non-default bearer of base station 12 (e.g., using radio-frequency signals 16). The QoS application may be a cellular telephone voice call application that conveys voice call data between UE device 10 and UE device 10′ via base station 12 (e.g., QoS data 26 may include QoS voice call packets). If desired, QoS data 26 may include a flag (e.g., one or more bits in a data payload, header, or other field of QoS data 26) identifying that QoS data 26 is QoS data or voice call data. Cellular network 22 identifies that QoS data 26 is QoS data based on the flag and/or the non-default bearer used to convey QoS data 26 and prioritizes QoS data 26 in the generation and implementation of the communications schedule for UE device 10 (e.g., using scheduler 2). By prioritizing QoS data 26, cellular network 22 can help to minimize dropped calls, garbled audio, and dropped packets, thereby maximizing voice call quality for UE device 10 (e.g., meeting a standardized QoS requirement associated with QoS data 26).

The software applications on UE device 10 may also include one or more non-quality-of-service (non-QoS or nQoS) applications that convey nQoS data 28 with host 18 or UE device 10′ via base station 12 (e.g., using radio-frequency signals 16). Unlike QoS data 26, nQoS data 28 flows on the default bearer of base station 12 and is not flagged or identified as QoS data. Whereas QoS data 26 includes QoS voice call packets, nQoS data 28 includes all other non-QoS application data conveyed by UE device 10 (e.g., voice-over-IP (VOIP) data, streaming audio data, streaming video data, internet browsing data, email data, text message data, message attachment data, etc.). If desired, UE device 10 may convey nQoS data 28 and QoS data 26 with base station 12 concurrently. If desired, UE device 10 may concurrently convey multiple streams of nQoS data 28 for multiple different nQoS applications on UE device 10.

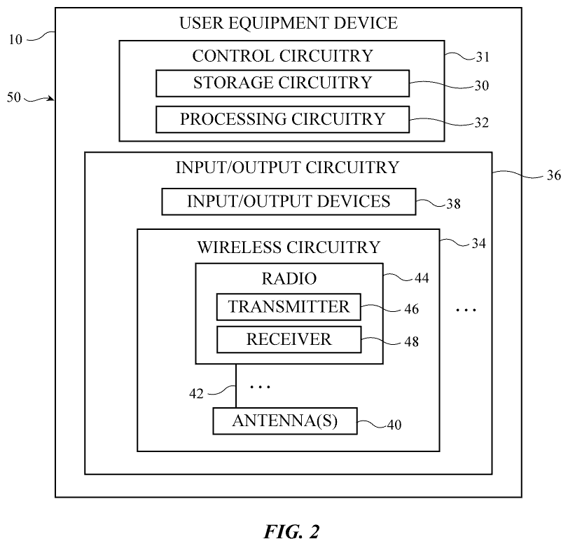

FIG. 2 is a block diagram of an illustrative UE device 10. UE device 10 is an electronic device and may therefore sometimes be referred to herein as electronic device 10 or device 10. UE device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in FIG. 2, UE device 10 may include components located on or within an electronic device housing such as housing 50. Housing 50, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 50 may be formed from dielectric or other low-conductivity material (e.g., glass, ceramic, plastic, sapphire, etc.). In other situations, housing 50 or at least some of the structures that make up housing 50 may be formed from metal elements.

UE device 10 may include control circuitry 31. Control circuitry 31 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 30 may include storage that is integrated within UE device 10 and/or removable storage media.

Control circuitry 31 may include processing circuitry such as processing circuitry 32. Processing circuitry 32 may be used to control the operation of UE device 10. Processing circuitry 32 may include on one or more processors such as microprocessors, microcontrollers, digital signal processors, host processors, baseband processor integrated circuits, application specific integrated circuits, central processing units (CPUs), graphics processing units (GPUs), etc. Control circuitry 31 may be configured to perform operations in UE device 10 using hardware (e.g., dedicated hardware or circuitry), firmware, and/or software. Software code for performing operations in UE device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 31 may be used to run software on device 10 such as one or more software applications (sometimes referred to herein simply as applications or apps). The applications (e.g., QoS applications and nQoS applications) may be stored at storage circuitry 30. The applications may include satellite navigation applications, internet browsing applications, voice-over-internet-protocol (VOIP) telephone call applications, email applications, media playback applications, operating system functions, gaming applications, productivity applications, workplace applications, augmented reality (AR) applications, extended reality (XR) applications, virtual reality (VR) applications, scheduling applications, consumer applications, social media applications, educational applications, banking applications, spatial ranging applications, sensing applications, security applications, media applications, streaming applications, automotive applications, video editing applications, image editing applications, rendering applications, simulation applications, camera-based applications, imaging applications, news applications, and/or any other desired software applications. The applications may generate and/or receive corresponding wireless data (e.g., nQoS data 28 of FIG. 1).

To support interactions with external communications equipment, control circuitry 31 may be used in implementing communications protocols. Communications protocols that may be implemented using control circuitry 31 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 3^{rd} Generation Partnership Project (3GPP) Fourth Generation (4G) Long Term Evolution (LTE) protocols, 3GPP Fifth Generation (5G) New Radio (NR) protocols, 6G protocols, cellular sideband protocols, etc.), device-to-device (D2D) protocols, antenna diversity protocols, satellite navigation system protocols (e.g., global positioning system (GPS) protocols, global navigation satellite system (GLONASS) protocols, etc.), satellite communications protocols (e.g., for conveying bi-directional data with one or more gateways via one or more communications satellites in a satellite constellation, antenna-based spatial ranging protocols, or any other desired communications protocols. Each communications protocol may be associated with a corresponding radio access technology (RAT) that specifies the physical connection methodology used in implementing the protocol (e.g., an NR RAT, an LTE RAT, a 3G RAT, a WLAN RAT, etc.). Radio-frequency signals conveyed using a cellular telephone protocol (e.g., radio-frequency signals 16 of FIG. 1) may sometimes be referred to herein as cellular telephone signals.

UE device 10 may include input-output circuitry 36. Input-output circuitry 36 may include input-output devices 38. Input-output devices 38 may be used to allow data to be supplied to UE device 10 and to allow data to be provided from UE device 10 to external devices. Input-output devices 38 may include user interface devices, data port devices, and other input-output components. For example, input-output devices 38 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to UE device 10 using wired or wireless connections (e.g., some of input-output devices 38 may be peripherals that are coupled to a main processing unit or other portion of UE device 10 via a wired or wireless link).

Input-output circuitry 36 may include wireless circuitry 34 to support wireless communications. Wireless circuitry 34 (sometimes referred to herein as wireless communications circuitry 34) may include one or more antennas 40. Wireless circuitry 34 may also include one or more radios 44. Radio 44 may include circuitry that operates on signals at baseband frequencies (e.g., baseband circuitry) and radio-frequency transceiver circuitry such as one or more radio-frequency transmitters 46 and one or more radio-frequency receivers 48. Transmitter 46 may include signal generator circuitry, modulation circuitry, mixer circuitry for upconverting signals from baseband frequencies to intermediate frequencies and/or radio frequencies, amplifier circuitry such as one or more power amplifiers, digital-to-analog converter (DAC) circuitry, control paths, power supply paths, switching circuitry, filter circuitry, and/or any other circuitry for transmitting radio-frequency signals using antenna(s) 40. Receiver 48 may include demodulation circuitry, mixer circuitry for downconverting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antenna(s) 40. The components of radio 44 may be mounted onto a single substrate or integrated into a single integrated circuit, chip, package, or system-on-chip (SOC) or may be distributed between multiple substrates, integrated circuits, chips, packages, or SOCs.

Antenna(s) 40 may be formed using any desired antenna structures for conveying radio-frequency signals. For example, antenna(s) 40 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antenna(s) 40 over time. If desired, two or more of antennas 40 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given/selected beam pointing direction (e.g., towards base station 12 of FIG. 1).

The term “convey radio-frequency signals” as used herein means the transmission and/or reception of the radio-frequency signals (e.g., for performing unidirectional and/or bidirectional wireless communications with external wireless communications equipment). Similarly, the term “convey wireless data” as used herein means the transmission and/or reception of wireless data using radio-frequency signals. Antenna(s) 40 may transmit the radio-frequency signals by radiating the radio-frequency signals into free space (or to free space through intervening device structures such as a dielectric cover layer). Antenna(s) 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Each radio 44 may be coupled to one or more antennas 40 over one or more radio-frequency transmission lines 42. Radio-frequency transmission lines 42 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission lines 42 may be integrated into rigid and/or flexible printed circuit boards if desired. One or more radio-frequency lines 42 may be shared between multiple radios 44 if desired. Radio-frequency front end (RFFE) modules may be interposed on one or more radio-frequency transmission lines 42. The radio-frequency front end modules may include substrates, integrated circuits, chips, or packages that are separate from radios 44 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission lines 42.

Radio 44 may transmit and/or receive radio-frequency signals within corresponding frequency bands at radio frequencies (sometimes referred to herein as communications bands or simply as “bands”). The frequency bands handled by radio 44 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, cellular sidebands, 6G bands between 100-1000 GHz (e.g., sub-THz, THz, or THF bands), etc.), other centimeter or millimeter wave frequency bands between 10-300 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest. Wireless circuitry 34 may also be used to perform spatial ranging operations if desired.

The example of FIG. 2 is illustrative and non-limiting. While control circuitry 31 is shown separately from wireless circuitry 34 in the example of FIG. 1 for the sake of clarity, wireless circuitry 34 may include processing circuitry (e.g., one or more processors) that forms a part of processing circuitry 32 and/or storage circuitry that forms a part of storage circuitry 30 of control circuitry 31 (e.g., portions of control circuitry 31 may be implemented on wireless circuitry 34). As an example, control circuitry 31 may include baseband circuitry (e.g., one or more baseband processors), digital control circuitry, analog control circuitry, and/or other control circuitry that forms part of radio 44. The baseband circuitry may, for example, access a communication protocol stack on control circuitry 31 (e.g., storage circuitry 30) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum (NAS) layer. If desired, the PHY layer operations may additionally or alternatively be performed by radio-frequency (RF) interface circuitry in wireless circuitry 34. UE device 10′ of FIG. 1 may include one or more (e.g., all) of the components of UE device 10 shown in FIG. 2.

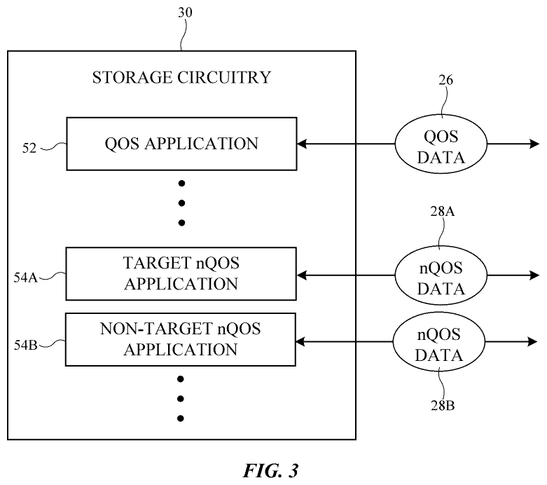

FIG. 3 is a diagram showing how different applications may be stored on storage circuitry 30. As shown in FIG. 3, storage circuitry 30 may store one or more QoS applications such as QoS application 52. If desired, QoS application 52 may be a first-party application associated with the operating system and/or manufacture of UE device 10. QoS application 52 may be a cellular telephone voice call application, for example. When executed by processing circuitry 32 (FIG. 2), QoS application 52 transmits QoS data 26 (e.g., packets of QoS data that includes voice data produced by a microphone in input/output devices 38 responsive to a user's voice) and/or receives QoS data 26 (e.g., packets of QoS data that include voice data produced by a microphone in UE device 10′ of FIG. 1) over, using, or in a corresponding QoS (non-default bearer) session with base station 12. Cellular network 22 prioritizes QoS data 26 over nQoS data when generating and implementing the communication schedule for UE device 10.

Storage circuitry 30 may also store two or more nQoS applications 54 such as at least a first nQoS application 54A and a second nQoS application 54B. nQOS applications 54 may include first-party applications and/or third-party applications. When executed by processing circuitry 32 (FIG. 2), each nQoS application 54 transmits a different respective stream of nQoS data 28 over a corresponding default bearer session with base station 12. For example, nQOS application 54A transmits and/or receives a first stream of nQoS data 28A over, using, or in a first Transmission Control Protocol (TCP) or default bearer session with base station 12. nQoS application 54B transmits and/or receives a second stream of nQoS data 28A over, using, or in a second TCP or default bearer session with base station 12. If desired, nQoS applications 54A and 54B may concurrently transmit and/or receive nQoS data 28A and nQoS data 28B, respectively.

During transmission of nQoS data 28, the corresponding nQoS application 54 generates the nQoS data 28 as digital baseband data (e.g., upon execution of nQoS application 54 by an application processor in processing circuitry 32 of FIG. 1). Baseband circuitry in radio 44 (FIG. 2) transmits the digital baseband data to radio 44, which converts the digital baseband data to analog nQoS data at a radio-frequency (e.g., by converting the digital baseband data to analog baseband data and then modulating a carrier using the nQoS data). Transmitter 46 in radio 44 (FIG. 2) then transmits the nQoS data to base station 12 using one or more antennas 40 (FIG. 2) (e.g., in radio-frequency signals 16 of FIG. 1). Cellular network 22 and core network 14 forward the nQoS data to the intended destination (e.g., host 18 or UE device 10′).

During reception of nQoS data 28, one or more antennas 40 (FIG. 2) receive radio-frequency signals 16 that carry the nQoS data from base station 12 (e.g., as forwarded to base station 12 by core network 14 and cellular network 22 from a source device such as host 18 or UE device 10′). Radio 44 (FIG. 2) recovers the nQoS data from the radio-frequency signals (e.g., by downconverting and demodulating the radio-frequency signals). Radio 44 passes the recovered nQoS data (as digital baseband data) to baseband circuitry, which is then processed by the application processor executing the corresponding nQoS application 54.

In practice, different nQoS applications 54 have different wireless data rate requirements for the transmission and/or reception of the corresponding nQoS data 28. For example, some nQOS applications 54 are more latency sensitive than other nQoS applications. Applications that are more latency sensitive generally require conveying the corresponding nQos data 28 with higher data rates than applications that are less latency sensitive (e.g., to allow execution of the applications without undesirably disrupting user experience with UE device 10).

In implementations that are described herein as an example, nQoS application 54A is more latency sensitive than nQoS application 54B. nQoS application 54A is therefore sometimes be referred to herein as target nQoS application 54A or simply as target application 54A. Similarly, nQoS data 28A is sometimes referred to herein as target nQoS data 28A or simply as target data 28A. On the other hand, nQoS application 54B is sometimes referred to herein as non-target nQoS application 54B or simply as non-target application 54B. Similarly, nQoS data 28B is sometimes referred to herein as non-target nQoS data 28B or simply as non-target data 28B.

Target application 54A may be, as examples, a latency sensitive nQoS application such as an audio and/or video streaming application (e.g., a music playback application, a video playback application, a social media or Internet browsing application with audio and/or video streaming features, a live streaming application, etc.), an audio and/or video-over-IP application (e.g., a video call and/or audio call-over-IP application, a video conferencing application, etc.), a game streaming application, a cloud gaming application (e.g., in which game processing is performed in a cloud region and streamed to UE device 10), an augmented reality (AR), virtual reality (VR), mixed reality (MR), or extended reality (XR) application, a foreground application (e.g., an application running in the foreground such that the user can actively interact with the application via a user input device such as a touch screen), or any other application that requires a latency less than a threshold latency and/or a data rate greater than a threshold data rate to ensure that the user does not notice or experience potential delays in conveying the corresponding nQoS data.

Non-target application 54B may be, as examples, a latency insensitive nQoS application such as a messaging application, an email application, an operating system update application, an Internet browser application (e.g., without streaming audio or video), a home security or smart appliance interface application, a cloud synchronization/storage application, a banking application, a navigation application, a social media application (e.g., without streaming audio or video), a background application (e.g., an application running in the background such that the user cannot actively interact with the application via a user input device such as a touch screen, at least until the operating system moves the application to the foreground), a fitness application, or any other application that does not require a latency less than a threshold latency and/or a data rate greater than a threshold data rate to ensure that the user does not notice or experience potential delays in conveying the corresponding nQoS data.

Cellular network 22 (FIG. 1) is able to identify that QoS data 26 is QoS data and prioritizes QoS data 26 accordingly. Unlike QoS data 26, cellular network 22 is unable to distinguish between different streams of nQoS data such as a first stream of nQoS data 28A and a second stream of nQoS data 28B. Put differently, cellular network 22 (e.g., scheduler 2) has no knowledge of the particular nQoS application 54 that produced a given stream of nQoS data 28, has no knowledge of whether a particular stream of nQoS data 28 is latency sensitive or not, and has no knowledge on how to differentiate between different packets or data flows on the default bearer. As such, cellular network 22 is unable to detect that target nQoS data 28A is latency sensitive and that non-target nQoS data 28B is not latency sensitive. On its own, cellular network 22 is unable to control the transmission of non-target nQoS data 28B in the DL direction when necessary to ensure that target nQoS data 28A meets its required target data rate given the current radio-frequency propagation conditions at UE device 10 and the current network load conditions.

In general, UE device 10 can control, reduce, and/or delay the UL transmission of non-target nQoS data 28B when needed to allow target application 54A to convey target nQoS data 28A with a sufficiently high data rate. However, UE device 10 has no control over the DL transmission of non-target nQoS data 28B by base station 12. Situations can therefore arise in which the receipt of non-target nQoS data 28B at UE device 10 can undesirably impair the conveyance of target nQoS data 28A. For example, when target application 54A is actively conveying target nQoS data 28A in constrained radio-frequency conditions and base station 12 concurrently transmits non-target nQoS data 28B to UE device 10 in the DL direction, the receipt of non-target nQoS data 28B by UE device 10 can prevent UE device 10 from successfully transmitting and/or receiving target nQoS data 28A with a sufficiently high data rate. This can cause an unexpected reduction in the data rate of target nQoS data 28A, which can disrupt user experience with UE device 10.

As one illustrative example, target application 54A may receive streaming video data in target nQoS data 28A. At the same time, base station 12 is unaware that target nQoS data 28A is latency sensitive and therefore concurrently transmits non-target nQoS data 28B to UE device 10 upon receiving the non-target nQoS data bound for UE device 10 (e.g., an email message, a text message, a message attachment, etc.). The receipt of the non-target nQoS data at UE device 10 causes a reduction in the data rate with which UE device 10 receives target nQoS data 28A, which can then cause target application 54A to stall, freeze, or stutter video playback, thereby disrupting user experience with UE device 10.

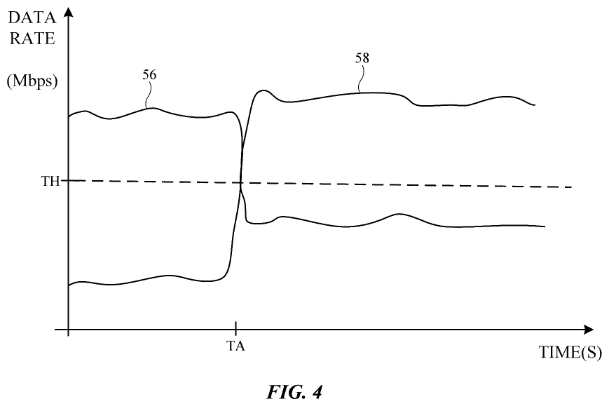

FIG. 4 is a plot of data rate versus time, illustrating how the reception of non-target nQoS data 28B for non-target application 54B can produce such a disruption in the conveyance of target nQoS data 28A for target application 54A at UE device 10. Curve 56 plots the data rate of target nQoS data 28A (e.g., of target application 54A in wirelessly conveying target nQoS data 28A) over time. Curve 58 plots the data rate of non-target nQoS data 28B (e.g., of non-target application 54B in wirelessly conveying non-target nQoS data 28B) over time.

Target application 54A may have a minimum data rate threshold TH. When UE device 10 conveys target nQoS data 28A at data rates above threshold TH, UE device 10 is able to execute target application 54A without producing noticeable disruptions to user experience with target application 54A. On the other hand, when UE device 10 conveys target nQoS data 28A at data rates below threshold TH, UE device 10 produces disruptions in the execution of target application 54A that are noticeable to the user (e.g., stalled, laggy, dropped, delayed, choppy, and/or otherwise disrupted video/audio streaming or calling).

As shown in FIG. 4, prior to time TA, target application 54A conveys target nQoS data 28A with base station 12 at data rates above threshold TH, allowing the user to interact with target application 54A without noticeable disruptions. However, at time TA, base station 12 begins transmitting non-target nQoS data 28B to UE device 10 in the DL direction. This causes a reduction in the data rate with which UE device 10 conveys target nQoS data 28A to data rates below threshold TH. The reduction in data rate for target nQoS data 28A below threshold TH produces noticeable disruptions to the user's interaction with target application 54A. As UE device 10 has no prior knowledge of when base station 12 will transmit non-target nQoS data 28B to UE device 10, if care is not taken, these disruptions are sudden and uncontrolled by UE device 10.

The example of FIG. 4 is illustrative and non-limiting. In practice, curves 56 and 58 may have other shapes. Additionally or alternatively, the reception of non-target nQoS data 28B concurrent with the conveyance of target nQoS data 28A by UE device 10 can also produce a decrease in the round trip time (RTT) of target nQoS data 28A (e.g., to below a minimum threshold RTT associated with noticeable disruptions to user experience with target application 54A). Additionally or alternatively, the reception of non-target nQoS data 28B concurrent with the conveyance of target nQoS data 28A by UE device 10 can produce unpredictable changes to the inter-arrival time of real-time transport protocol (RTP) packets transmitted from base station 12 to UE device 10, which can disrupt user experience with target application 54A.

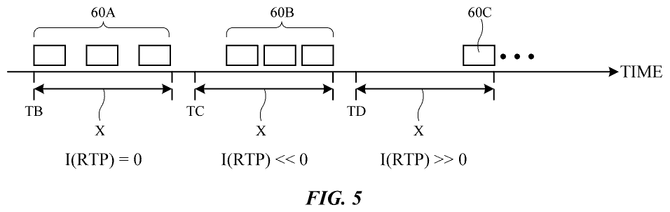

FIG. 5 is a timing diagram showing how the reception of non-target nQOS data 28B concurrent with the conveyance of target nQoS data 28A by UE device 10 can produce changes to the inter-arrival time of real-time transport protocol (RTP) packets transmitted from base station 12 to UE device 10.

As shown in FIG. 5, a source device (e.g., host 18 or UE device 10′ of FIG. 1) may transmit a flow of DL RTP packets (RTP TS) 60 to UE device 10 via base station 12 (e.g., as target nQoS data 28A). RTP packets 60 run over the user datagram protocol (UDP) and may, for example, deliver audio and/or video data to UE device 10 over IP. Each RTP packet 60 is labeled by the source device (e.g., includes) a corresponding sequence number (SN) that allows UE device 10 to know the order with which each RTP packet is intended to be received. For every moving average time window X, UE device 10 calculates the inter-arrival time I(RTP) of RTP packets 60 using the formula I(RTP)=(RXTS_{Y}−RXTS_{X})−(TXTS_{Y}−TXTS_{X}), where RXTS_{X} is the timestamp at which UE device 10 receives a first RTP packet 60, RXTS_{Y} is the timestamp at which UE device receives a second RTP packet 60 that is subsequent to the first RTP packet in the flow, TXTS_{X} is the timestamp at which the source device transmitted the first RTP packet (e.g., the source device may include the transmit timestamps within the RTP packets), and TXTS_{Y} is the timestamp at which the source device transmitted the second RTP packet.

When UE device 10 is not receiving non-target nQoS data 28B, RTP packets 60 are received with a uniform time spacing across moving average time window X such that I(RTP)=0, as shown by RTP packets 60A in FIG. 5. When UE device 10 is concurrently receiving non-target nQoS data 28B, the reception of non-target nQoS data 28B can cause RTP packets 60 to be received with a non-uniform time spacing across moving average time window X. For example, UE device 10 may receive RTP packets 60B within a moving average time window X beginning at time TC with an I(RTP)<<0 and/or may receive RTP packet(s) 60C within a moving average time window X beginning at time TD with an I(RTP)>>0.

The examples of FIGS. 3-5 show a simplest case in which a single non-target application 54B conveys a corresponding stream of non-target nQoS data 28B for the sake of illustration. In general, UE device 10 may concurrently execute multiple non-target applications 54B that each require a different respective stream of nQoS data 28, that each have different latency requirements, and that are each associated with a different priority level.

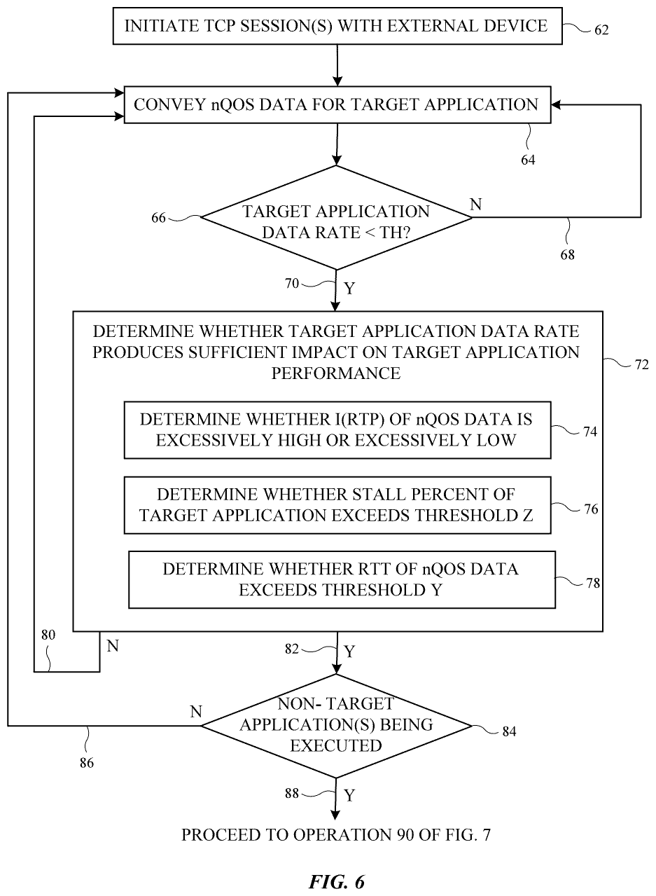

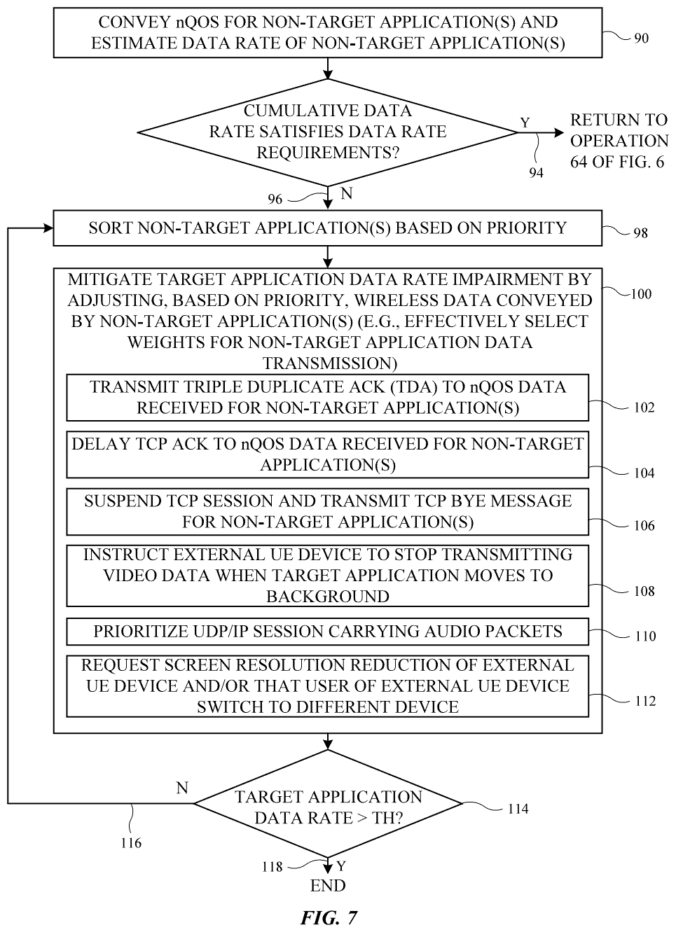

If care is not taken, receipt of non-target nQoS data 28B for one or more non-target applications 54B concurrent with conveyance of target nQoS data 28A can undesirably raise the RTT, reduce the data rate, and/or alter the I(RTP) of the target nQoS data 28A such that user experience with target application 54A is disrupted. FIGS. 6 and 7 show a flow chart of illustrative operations that may be performed by UE device 10 to detect and mitigate these disruptions to target nQoS data 28A and target application 54A (as produced by the concurrent reception of non-target nQoS data 28B from base station 12). An example in which target nQoS data 28A includes streaming video and/or audio data for target application 54A is sometimes described herein for the sake of illustration. However, in general, target application 54A may be any desired nQoS application that is more latency sensitive than one or more non-target applications 54B and target nQoS data 28A may include any desired type of wireless data.

At operation 62, UE device 10 may initiate one or more Transmission Control Protocol (TCP) sessions with one or more external devices (e.g., host(s) 18 UE device(s) 10′ of FIG. 1) via base station 12. UE device 10 may initiate a respective TCP session with a respective external device for each application that has wireless data to be conveyed to and/or from the external device. For example, UE device 10 and a first external device may initiate a first TCP session for conveying a stream of target nQoS data 28A for target application 54A. If desired, UE device 10 and a second external device may concurrently initiate a second TCP session for conveying a first stream of non-target nQoS data 28B for a first non-target application 54B.

If desired, UE device 10 and one or more additional external devices may initiate additional TCP sessions for conveying additional streams of non-target nQoS data for additional non-target applications having different priority levels. UE device 10 may and each external device may initiate a corresponding TCP session by performing a three-way handshake via base station 12 (e.g., in which the external device transmits a first TCP synchronization (SYN) signal, UE device 10 transmits a second TCP synchronization signal that acknowledges (ACKs) the first TCP synchronization signal, and the external device transmits a TCP acknowledgement (ACK) to the second TCP synchronization signal, or vice versa).

At operation 64, UE device 10 may convey target nQoS data 28A for target application 54A with the first external device via base station 12 (e.g., in the corresponding first TCP session). If desired, UE device 10 may concurrently convey the first stream of non-target nQoS data 28B for non-target application 54B with the second external device via base station 12 (e.g., in the corresponding second TCP session) and/or additional streams of non-target nQoS data with additional external devices for additional non-target applications. Control circuitry 31 (FIG. 1) may monitor the data rate of the target nQoS data 28A conveyed by UE device 10. UE device 10 may continue to convey target nQoS data 28A and/or non-target nQoS data 28B during one or more of the subsequent operations of FIGS. 6 and 7 if desired.

At operation 66, control circuitry 31 may determine (e.g., detect, identify, compute, measure, etc.) whether the data rate of target nQoS data 28A (target application 54A) is less than or has fallen below threshold TH (FIG. 4). If the data rate of target nQoS data 28A is greater than or equal to threshold TH, this means that target application 54A can continue to execute without producing disruptions that are noticeable to the user and UE device 10 may continue to convey target nQoS data 28A without performing data rate impairment mitigation operations (e.g., processing may loop back to operation 64 via path 68). If the data rate of target nQoS data 28A is less than or falls below threshold TH, processing may proceed to operation 72 via path 70.

At operation 72, control circuitry 31 may determine (e.g., detect, identify, compute, measure, etc.) whether the detected data rate of target nQoS data 28A will produce a sufficient impact on the operation or execution of target application 54A so as to be noticeable to a user or to otherwise detriment user experience. As not all reductions in the data rate of target nQoS data 28A will produce a sufficient impact to warrant mitigation, this operation may allow UE device 10 to mitigate the reduction in data rate only when sufficient impact would occur. If control circuitry 31 determines that the low data rate will not produce sufficient impact on the performance of target application 54A and/or user experience, processing may loop back to operation 64 via path 80 and UE device 10 may continue to convey target nQoS data 28A without further mitigation operations. However, if control circuitry 31 determines that the low data rate will produce sufficient impact on the performance of target application 54A and/or user experience, processing may proceed to operation 84 via path 82.

Control circuitry 31 may utilize any desired processing logic to determine whether the low/reduced data rate of target nQoS data 28A will produce sufficient impact on the performance of target application 54A and/or user experience. For example, at operation 74, control circuitry 31 may determine (e.g., detect, identify, compute, measure, etc.) whether the inter-arrival time of RTP packets I(RTP) in target nQoS data 28A is excessively high (e.g., I(RTP)>>0) or excessively low (e.g., I(RTP)<<0) (e.g., when the absolute value of I(RTP) exceeds a threshold). Inter-arrival time I(RTP) generally affects the latency of target application 54A. As such, by characterizing inter-arrival time I(RTP), UE device 10 can determine whether the reduction in data rate of target nQoS data 28A will have sufficient impact on the latency of target application 54A. Additionally or alternatively, control circuitry 31 may determine whether, for a subsequent moving average time window X, the total number of received packets divided by the difference between the highest RTP packet sequence number and the lowest RTP packet sequence number exceeds a threshold value.

If I(RTP)>>0, I(RTP)<<0, or the total number of received packets divided by the difference between the highest RTP packet sequence number and the lowest RTP packet sequence number exceeds the threshold value, control circuitry 31 may determine that the low data rate of target nQoS data 28A produces sufficient impact on target application performance to proceed to operation 84 via path 82. On the other hand, if I(RTP) is around 0 or the total number of received packets divided by the difference between the highest RTP packet sequence number and the lowest RTP packet sequence number is less than the threshold value, control circuitry 31 may determine that the low data rate of target nQoS data 28A does not produce sufficient impact on target application performance and processing may loop back to operation 64 via path 80.

Additionally or alternatively, at operation 76, control circuitry 31 may determine (e.g., detect, identify, compute, measure, etc.) whether the stall percentage of target application 54A exceeds or will exceed a minimum threshold Z. The stall percentage may characterize the amount of a video or audio stream in target nQoS data 28A that freezes or stalls during playback by target application 54A. In general, lower data rates for target nQoS data 28A will produce greater stall percentages and higher data rates will produce lower stall percentages. If the stall percentage exceeds threshold Z, control circuitry 31 may determine that the low data rate of target nQoS data 28A produces sufficient impact on target application performance to proceed to operation 84 via path 82. On the other hand, if the stall percentage is less than threshold Z, control circuitry 31 may determine that the low data rate of target nQoS data 28A does not produce sufficient impact on target application performance and processing may loop back to operation 64 via path 80.

Additionally or alternatively, at operation 78, control circuitry 31 may determine (e.g., detect, identify, compute, measure, etc.) whether the RTT of target nQoS data 28A exceeds or will exceed a minimum threshold Y. If the RTT exceeds threshold Y, control circuitry 31 may determine that the low data rate of target nQoS data 28A produces sufficient impact on target application performance to proceed to operation 84 via path 82. On the other hand, if the RTT is less than threshold Y, control circuitry 31 may determine that the low data rate of target nQoS data 28A does not produce sufficient impact on target application performance and processing may loop back to operation 64 via path 80.

In general, processing may proceed from operation 72 to operation 84 via path 82 when I(RTP)>>0, I(RTP)<<0, the total number of received packets divided by the difference between the highest RTP packet sequence number and the lowest RTP packet sequence number exceeds the corresponding threshold value, stall percentage exceeds threshold Z, RTT exceeds threshold Y, and/or when any other desired performance metric information associated with the operation of target application 54A based on target nQoS data 28A otherwise lies outside a range of satisfactory values.

At operation 84, control circuitry 31 may determine whether non-target applications 54B are being executed on UE device 10. If no non-target applications 54B are being executed (or if no non-target applications 54B have a corresponding TCP session with base station 12), UE device 10 will not receive non-target nQoS data 28B that can impair the data rate of target nQoS data 28A, and processing may loop back to operation 64 via path 86 until a non-target application 54B is executed. If one or more non-target applications 54B are being executed (or have a corresponding active TCP session with base station 12), there is a risk that UE device 10 will receive non-target nQoS data 28B that will impair the data rate of target nQoS data 28A and processing may proceed to operation 90 of FIG. 7 via path 88.

At operation 90 of FIG. 7, UE device 10 may convey or may continue to convey non-target nQoS data 28B the corresponding external device(s) via base station 12 for the one or more non-target applications 54B being executed at UE device 10. Control circuitry 31 may determine (e.g., estimate, detect, identify, compute, measure, etc.) the data rate of each stream of non-target nQoS data 28B and each corresponding non-target application 54B. Additionally or alternatively, control circuitry 31 may determine, estimate, or predict the data rate of each stream of non-target nQoS data 28B by querying information (e.g., UE statistics) from database 4 of cloud region 24 (FIG. 1) for the corresponding cell or base station 12. Control circuitry 31 may combine the estimated data rates for the stream(s) of non-target nQoS data 28B with the data rate for target nQoS data 28A to generate or estimate a cumulative data rate for all of the nQoS data being conveyed by UE device 10.

At operation 92, control circuitry 31 may determine whether the cumulative data rate satisfies a data rate requirement for UE device 10. The cumulative data rate may satisfy the data rate requirement when (i) the data rate of target nQoS data 28A (target application 54A) is greater than or equal to the sum of the data rates of each stream of non-target nQoS data 28B (each non-target application 54B) and (ii) the sum of the data rate of target nQoS data 28A and the data rates is approximately equal to (e.g., within 1-20% of) the threshold TH of the data rate for target nQoS data 28A, for example. If the data rate requirement is satisfied, processing may loop back to operation 64 of FIG. 6 via path 94. If the data rate requirement is not satisfied, processing may proceed from operation 92 to operation 98 via path 96.

At operation 98, control circuitry 31 may sort (group) each of the executed non-target applications 54B into one or more corresponding groups (sets) of non-target applications based on the priority of the non-target applications. As an example, non-target applications 54B that are more latency sensitive or that require more user interaction or attention may be sorted into a first group associated with a first priority whereas non-target applications 54B that are less latency sensitive or that require less user interaction or attention are sorted into a second group associated with a second priority less than the first priority. As another example, non-target applications 54B that consume the most data rate may be sorted into a highest priority group, non-target applications 54B that operate in the background may be sorted into a moderate priority group, and latency insensitive non-target applications 54B may be sorted into a lowest priority group. In general, there may be any desired number of groups (e.g., where the non-target applications 54B within each group have similar priority and there are different priorities between the groups).

At operation 100, control circuitry 31 may perform one or more mitigation operations that serve to mitigate impairment to the data rate of target nQoS data 28A and target application 54A by the reception of the stream(s) of non-target nQoS data 28B for non-target application(s) 54B (e.g., based on the priorities of the non-target application(s) 54B and/or the groups as sorted at operation 98). Control circuitry 31 may, for example, perform one or more of mitigation operations 102-112 to mitigate the impairment to the data rate of target nQoS data 28A and target application 54A produced by non-target nQoS data 28B. The mitigation operation(s) may serve to boost the data rate of target nQoS data 28A, thereby eliminating impact to user experience with target application 54A.

The mitigation operation(s) performed at operation 100 may effectively reduce the data rate(s) of the non-target application(s) 54B, such that equation 1 is satisfied.

$$D ( tgt ) + α {\sum }_{i = 1}^{N} D ( {ntgt}_{i} ) + β {\sum }_{j = 1}^{M} D ( {ntgt}_{j} ) + ⋯ \approx TH \qquad ( 1 )$$

In equation 1, D(tgt) is the data rate of target application 54A and target nQoS data 28A. D(ntgtᵢ) is the data rate of the i^{th} non-target application 54B from a first group of N non-target applications 54B having similar priority and D(ntgtⱼ) is the data rate of the j^{th} non-target application 54B from a second group of M non-target applications 54B having similar priority but different from the first priority (e.g., as sorted at operation 98). The constant α is a weighting factor for the non-target applications 54B in the first group and the constant β is a weighting factor for the non-target applications 54B in the second group.

Performing one or more of mitigation operations 102-112 may serve to effectively set constants α and β, scaling back or throttling the data rate of the first and second groups of non-target applications 54B respectively such that equation 1 is satisfied. In an example where the first group of non-target applications 54B are higher priority (e.g., more latency sensitive) than the second group of non-target applications 54B, constant α is greater than constant β, for example. By satisfying equation 1, target application 54A is able to continue to convey target nQoS data 28A without producing a noticeable impact to the user of UE device 10. The example in which non-target applications 54B are sorted into two groups based on relative priority is illustrative and non-limiting. In general, there may be more than two groups of non-target applications 54B for more than two different relative priorities (e.g., where the data rates for each group are weighted by different respective weighting factors) or there may be just a single non-target application 54B, in which case equation 1 simplifies to D(tgt)+αD(ntgt)≅TH.

UE device 10 may perform one or more of mitigation operations 102-112 to effectively satisfy equation 1 and boost the data rate of target application 54A and target nQoS data 28A. UE device 10 may perform two or more of operations 102-112 concurrently if desired. UE device 10 may omit one or more of operations 102-112 if desired. UE device 10 may perform different mitigation operations on different streams of non-target nQoS data 28B, may perform the same mitigation operations on multiple streams of non-target nQoS data 28B, and/or may perform multiple mitigation operations on the same stream of non-target nQoS data 28B if desired (e.g., where each stream is associated with a different respective non-target application 54B).

At operation 102, UE device 10 (e.g., radio 44 of FIG. 2) may transmit a TCP triple duplicate acknowledgement (TDA) to one or more streams of non-target nQoS data 28B received for one or more non-target applications 54B. Under TCP signaling, UE device 10 transmits an acknowledgement (ACK) packet to each packet of DL data (e.g., non-target nQoS data 28B) received from base station 12. Cellular network 22 and core network 14 forward the TDA to the corresponding external device (e.g., host 18 or UE device 10′ of FIG. 1). The TDA includes the ACK packet to a given packet of non-target nQoS data 28B received at UE device 10, followed immediately by sequence of two duplicate ACKs to the given packet of non-target nQoS data 28B (e.g., the TDA includes a burst of three identical time-sequential ACK packets to the given packet of non-target nQoS data 28B received from base station 12).

The external device that conveys a given stream of non-target nQoS data 28B with UE device 10 maintains a TCP congestion window (CWND) for its TCP session with UE device 10 (e.g., for a corresponding non-target application 54B). The congestion window limits the total number of unacknowledged packets that are conveyed between the external device and UE device 10 for the TCP session. By transmitting the TDA in response to a given packet of non-target nQoS data 28B, UE device 10 effectively (e.g., falsely) causes or forces the external device to reduce the size of the corresponding congestion window CWND for the stream of non-target nQoS data 28B (e.g., even though UE device 10 otherwise has no direct control over the transmission of DL non-target nQoS data by base station 12 to UE device 10). The reduction in congestion window size for non-target nQoS data 28B serves to reduce the data rate of the stream of non-target nQoS data 28B in the downlink direction (e.g., effectively reducing the corresponding weighting factor for the stream of non-target nQoS data 28B in equation 1), which effectively boosts the data rate of the stream of target nQoS data 28A conveyed by UE device 10. If desired, UE device 10 may increase the rate with which the TDA is transmitted over time to further reduce congestion window size and boost the data rate of target nQoS data 28A until the data rate rises to a satisfactory level (e.g., greater than threshold TH).

At operation 104, UE device 10 may proactively/purposefully delay transmission of a TCP ACK packet to a given packet of non-target nQoS data 28B received from the external device via base station 12. For example, UE device 10 may be scheduled to receive the given packet of non-target nQoS data 28B at a first time (e.g., based on the communication schedule generated by scheduler 2 of FIG. 1). UE device 10 may be scheduled to transmit an ACK packet to the given packet of non-target nQoS data 28B at a second time after the first time (e.g., after a first duration has elapsed since the first time, according to the specifications of the TCP and/or the communications protocol governing radio-frequency signals 16 of FIG. 1). However, rather than transmitting the ACK packet at the second time, UE device 10 may delay transmission of the ACK packet until a third time after the second time (e.g., after a second duration greater than the first duration has elapsed since the first time). The external device is unable to distinguish between this intentional delay in ACK transmission by UE device 10 and an incidental delay associated with deteriorated radio-frequency propagation/channel conditions at UE device 10. As such, the delay in ACK transmission effectively slows the transmission of subsequent non-target nQoS data 28B from the same stream (for the same non-target application 54B), causing an effective reduction in the data rate of non-target nQoS data 28B, thereby allowing UE device 10 to boost the data rate for target nQoS data 28A (e.g., to greater than threshold TH).

At operation 106, UE device 10 may suspend/terminate the TCP session associated with a given stream of non-target nQoS data 28B. For example, UE device 10 may transmit a TCP session termination message (e.g., a TCP BYE message or another message) to the external device via base station 12, which serves to end the TCP session associated with the given stream of non-target nQoS data 28B and the corresponding non-target application 54B. After receiving the TCP BYE message, the external device may attempt to re-initiate the terminated TCP session with UE device 10. However, UE device 10 may forego re-initiation of the TCP session in response to the attempt by the external device. By ending the TCP session associated with the given stream of non-target nQoS data 28B and the corresponding non-target application 54B, UE device 10 frees resources for target application 54A and effectively boosts the data rate of the corresponding target nQoS data 28A (e.g., to greater than threshold TH). If desired, suspending/ending a TCP session may serve as a worst case scenario for UE device 10 (e.g., UE device 10 may perform operation 106 when one or more of the other mitigation operations fail to produce a sufficient increase in the data rate of target nQoS data 28A).

In scenarios where target nQoS data 28A includes video data (e.g., for a streaming video or video call target application 54A) and the external device is another UE device such as UE device 10′ of FIG. 1, UE device 10 may transmit a message instructing UE device 10′ to stop transmitting video data when target application 54A moves from the foreground to the background on UE device 10 (at operation 108). If desired, UE device 10′ may continue to transmit audio data corresponding to the video data. UE device 10 may transmit the message using in-band communications, for example. This may serve to prevent disruptions to the audio data even in the event that non-target nQoS data 28B is received at UE device 10 for non-target application(s) 54B. When UE device 10 moves target application 54A from the background back to the foreground, UE device 10 may transmit an in-band message to UE device 10′ to resume transmission of audio data.

At operation 110, UE device 10 may prioritize UDP/IP sessions that carry audio packets. This may serve to guarantee audio packet transmission/reception. For example, UE device 10 may identify a lossy scenario and may propose a feedback mechanism with UE device 10′ (or using SIP/enhanced RTP control protocol (RTCP) messages when UE device 10′ is a cross-platform device) to identify audio lag and/or video lag associated with a stream of data that includes the audio packets. In these scenarios, the CDP DL/UL system on UE device 10 may identify user-experience impacting packets for a session and may prioritize transfer of those packets.

In scenarios where target nQoS data 28A includes video data (e.g., for a streaming video or video call target application 54A) and the external device is another UE device such as UE device 10′ of FIG. 1, UE device 10 may transmit a request to UE device 10′ to reduce the resolution and/or aspect ratio of the video data transmitted by UE device 10′. For example, when UE device 10′ has a display with a higher resolution and/or aspect ratio than UE device 10 and UE device 10 originates a video call with UE device 10′ using target application 54A, UE device 10 may request that UE device 10′ begin transmitting video at the lower resolution and/or aspect ratio of UE device 10, which can help to minimize stalling of the video as played back at UE device 10. Additionally or alternatively, UE device 10 may transmit a request to UE device 10′ for the user of UE device 10′ to switch to a different device with lower screen resolution to continue the video call with UE device 10.

At operation 114, control circuitry 31 may determine whether the mitigation operation(s) performed while processing operation 100 has caused the data rate of target nQos data 28A to exceed threshold TH. If the data rate of target nQoS data 28A is greater than or equal to threshold TH, processing may loop back to operation 98 via path 116 to continue to perform additional mitigations until the data rate of target nQoS data 28A is sufficient. When the data rate of target nQoS data 28A is greater than or equal to threshold TH, the data rate is sufficient so as not to deteriorate or impact user experience with target application 54A and processing may end (path 118).

The example of FIGS. 6 and 7 is illustrative and non-limiting. Alternatively, operations 62-92 may be replaced with any desired processing logic to determine when UE device 10 needs to mitigate data rate impairment for target application 54A. For example, operations 62-92 may be replaced with a single operation in which control circuitry 31 determines whether or not to perform the mitigation of operation 100 (FIG. 7) based a theoretical data rate for target application 54A in its current (or expected future) cell and/or a predicted data rate for target application 54A in its current (or expected future) cell as identified by data base 4 in cloud region 24 (FIG. 1).

In this example, control circuitry 14 may query, from cloud region 24, the entry of database 4 corresponding to the current or expected future cell of UE device 10. UE device 10 may receive the UE statistics of the queried entry from cloud region 24. Control circuitry 31 may identify, from the received UE statistics, the average or historical data rate of target application 54A as achieved by other UE devices executing the same target application 54A in the past within its current or expected future cell. Control circuitry 31 may also estimate (calculate) the theoretical data rate for target application 54A in its current or expected future cell. Control circuitry 31 may estimate the theoretical data rate by combining (e.g., multiplying) the user radio-frequency conditions per band and RAT, the average scheduling rate (e.g., in time and frequency) per band, the number of active carriers (e.g., under the current carrier aggregation scheme), and/or the current signal-to-noise ratio (SNR) and modulation coding scheme (MCS) allocation for UE device 10, for example. Control circuitry 31 may then compare the lower of the theoretical data rate and the average/historical data rate to threshold TH. If/when the lower of the theoretical data rate and the average/historical data rate exceed threshold TH, UE device 10 may convey target nQoS data 26A without performing mitigation operations (e.g., operation 100 of FIG. 7). On the other hand, if/when the lower of the theoretical data rate and the average/historical data rate is below threshold TH, UE device 10 may perform one or more mitigation operations (e.g., processing may proceed to operation 100 of FIG. 7).

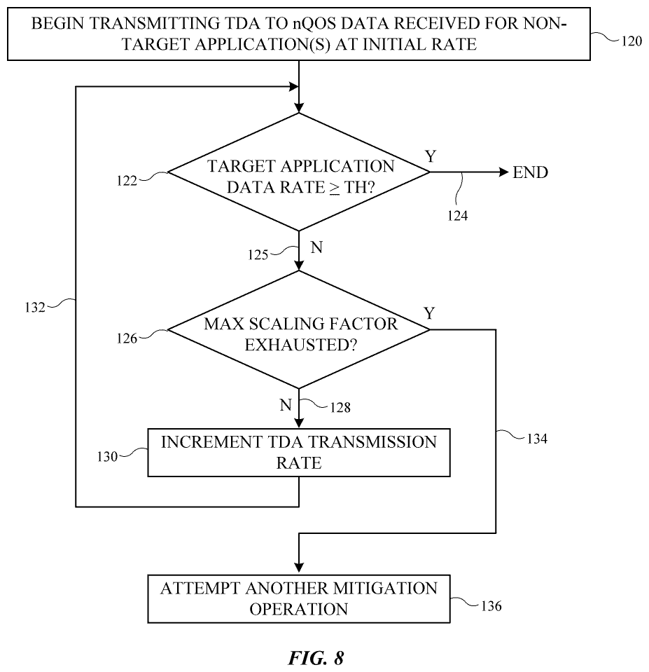

FIG. 8 is a flow chart of operations that may be performed by UE device 10 to mitigate data rate impairment of target nQoS data 28A via transmission of a TDA to non-target nQoS data 28B. The operations of FIG. 8 may, for example, be performed while iterating over operations 102 and 114 of FIG. 7.

At operation 120, UE device 10 may begin transmitting a TDA to a given stream of non-target nQoS data 28B and the corresponding non-target application 54B at an initial rate (e.g., a default triple duplicate ACK rate).

At operation 122 (e.g., operation 114 of FIG. 7), control circuitry 31 may determine whether the decrease in the congestion window of the stream of non-target nQoS data 28B produced by transmission of the TDA has caused the data rate of target nQoS data 28A to exceed threshold TH. If the data rate of target nQoS data 28A is greater than or equal to threshold TH, the data rate is sufficient so as not to deteriorate or impact user experience with target application 54A and processing may end (path 124). If the data rate of target nQoS data 28A is less than threshold TH, processing may proceed to operation 126 via path 125.

At operation 126, control circuitry 31 may determine whether the maximum scaling factor of TDA transmission has been exhausted. Put differently, control circuitry 31 may determine whether the rate of TDA transmission may be further increased. If (when) the maximum scaling factor of TDA transmission has not been exhausted (e.g., if/when the rate of TDA transmission can be further increased), processing proceeds to operation 130 via path 128.

At operation 130, control circuitry 31 may increase (increment) the rate of TDA transmission for the stream of non-target nQoS data 28B. UE device 10 may transmit the TDA responsive to a subsequent packet of the stream of non-target nQoS data 28B at the increased (incremented) rate. Processing may loop back to operation 122 via path 132 until the maximum scaling factor of TDA transmission has been exhausted. When the maximum scaling factor of has been exhausted (e.g., if/when the rate of TDA transmission can no longer be increased) and the data rate of target nQoS data 28A is still less than threshold TH, processing may proceed from operation 126 to operation 136 via path 134.

At operation 136, UE device 10 may attempt another mitigation operation (e.g., one or more of mitigation operations 104-112 of FIG. 7) to further boost the data rate of target nQoS data 28A above threshold TH.

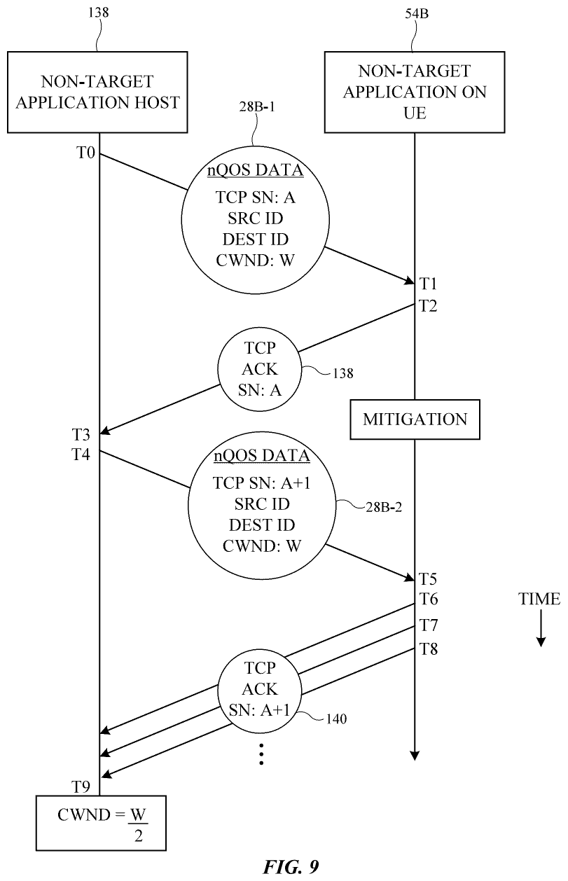

FIG. 9 is a timing diagram showing how UE device 10 may transmit a TDA to non-target nQoS data 28B (e.g., while processing operation 102 of FIG. 7 and operation 120 of FIG. 8). As shown in FIG. 9, the external device that conveys non-target nQoS data 28B with UE device 10 (sometimes referred to herein as non-target application host 138) may transmit a first packet of 28B-1 of nQoS data to UE device 10 via cellular network 22 and base station 12. Packet 28B-1 may have a corresponding sequence number A identifying the place of packet 28B-1 in the corresponding stream of non-target nQoS data 28B. Packet 28B-1 may include a source identifier (SRC ID) identifying the source of packet 28B-1 (e.g., non-target application host 138), a destination (DEST ID) identifying UE device 10, a corresponding data payload (not shown), and information (e.g., one or more bits) identifying sequence number A. Non-target application host 138 and base station 12 may transmit packet 28B-1 using a corresponding congestion window (CWND) of size W.

The non-target application 54B on UE device 10 corresponding to the stream of non-target nQoS data 28B may receive packet 28B-1 at time T1. UE device 10 may transmit a TCP ACK packet 138 to packet 28B-1 at time T2. ACK packet 138 may include or identify the sequence number A of packet 28B-1 that ACK packet 138 is acknowledging (e.g., may identify that ACK packet 138 is an ACK to packet 28B-1 rather than some other packet).

Non-target application host 138 receives ACK packet 138 at time T3. Non-target application host 138 may identify that UE device 10 has successfully received packet 28B-1 based on the sequence number A identified by ACK packet 138. Since UE device 10 has acknowledged successful receipt of packet 28B-1, non-target application host 138 may then transmit the next (e.g., second) packet 28B-2 of the stream of non-target nQoS data 28B at time T4.

Packet 28B-2 may have a corresponding sequence number A+1 identifying the place of packet 28B-2 in the corresponding stream of non-target nQoS data 28B (e.g., identifying that packet 28B-2 is the next packet from the stream of non-target nQoS data 28B after packet 28B-1). Packet 28B-2 may include a source identifier (SRC ID) identifying the source of packet 28B-1 (e.g., non-target application host 138), a destination (DEST ID) identifying UE device 10, a corresponding data payload (not shown), and information (e.g., one or more bits) identifying sequence number A+1. Non-target application host 138 and base station 12 may transmit packet 28B-2 using a corresponding congestion window (CWND) of size W.

UE device 10 receives packet 28B-2 at time T5. UE device 10 begins to perform target application data rate impairment mitigation between times T2 and T5 (e.g., UE device 10 transitions to operation 100 of FIG. 7 between times T2 and T5). Rather than transmitting a single ACK to packet 28B-2, UE device 10 may transmit a TDA 140 to packet 28B-2 beginning at time T6. TDA 140 may include three identical/duplicate copies of the same TCP ACK packet (e.g., transmitted at consecutive times T6, T7, and T8 respectively), each of which identifies the sequence number A+1 of packet 28B-2. Times T6-T8 may be separated by a duration less than 1-100 ms, as an example.

Non-target application host 138 receives TDA 140 at time T9. Receipt of TDA 140 may cause non-target application host 138 and/or base station 12 to reduce the size of the congestion window CWND for the stream of non-target nQoS data 28B-1 (e.g., to size W/2). This may serve to effectively reduce the data rate of the stream of non-target nQoS data 28B-1, allowing UE device 10 to increase the data rate of target nQoS data 28A. UE device 10 may adjust the rate of TDA transmission by reducing the separation between times T6-T8 and/or by adjusting the duration between re-transmissions of TDA 140.

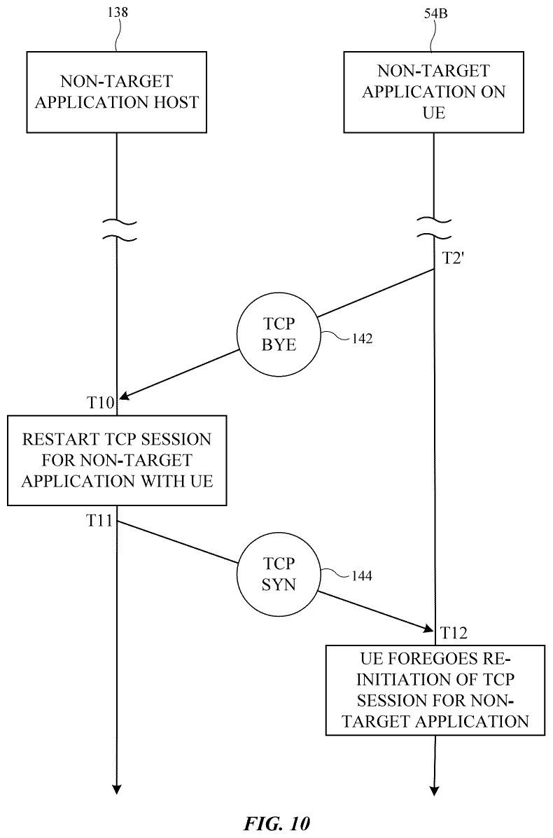

FIG. 10 is a timing diagram showing how UE device 10 may end a TCP session of a non-target application 54B to boost the data rate of target nQoS data 28A (e.g., while processing operation 106 of FIG. 7). The timing diagram shown in FIG. 10 begins after UE device 10 has received packet 28B-1 of FIG. 9.

As shown in FIG. 10, at time T2′ (e.g., after time T1 of FIG. 9), non-target application 54B on UE device 10 may transmit a TCP BYE message 142 (e.g., one or more TCP BYE packets) to non-target application host 138 via base station 12 (FIG. 1). Non-target application host 138 receives TCP BYE message 142 at time T10. TCP BYE message 142 instructs non-target application host 138 to restart the TCP session associated with non-target application 54B (e.g., between times T10 and T11).

After restarting the TCP session, non-target application host 138 attempts to re-initialize or establish the TCP session for non-target application 54B by transmitting a TCP synchronization message/packet (TCP SYN) at time T11. UE device 10 receives TCP synchronization message 144 at time T12. Rather than responding to TCP synchronization message 144 (e.g., with a corresponding ACK/SYN packet), which could otherwise be used by non-target application host 138 to re-establish the TCP session, UE device 10 instead foregoes transmission of the response and thereby foregoes re-initiation of the TCP session for non-target application 54B after time T12. This allows UE device 10 to boost the data rate of target application 54A.

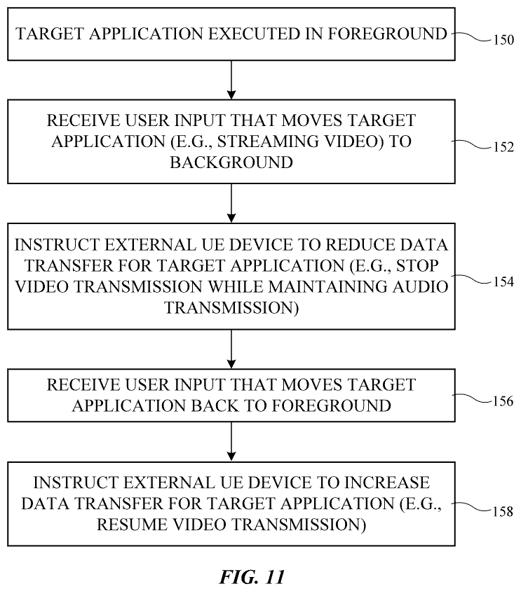

FIG. 11 is a flow chart of illustrative operations that may be performed by UE device 10 to instruct UE device 10′ to stop transmitting video data when target application 54A moves to the background (e.g., in scenarios where target nQoS data 28A includes video and audio data). The operations of FIG. 11 may, for example, be performed while processing operation 108 of FIG. 7.

At operation 150, UE device 10 executes target application 54A in the foreground. Target application 54A conveys target nQoS data 28A with UE device 10′ (e.g., via base station 12)

At operation 152, UE device 10 receives a user input (e.g., a touch input provided to a touch screen on UE device 10) or a software trigger that causes the operating system of UE device 10 to move target application 54A from the foreground to the background. When operating in the background, target application 54A stops displaying the video data on the display but may, if desired, continue to play the corresponding audio data (e.g., on a speaker of UE device 10, over headphones coupled to UE device 10, etc.).

At operation 154, target application 54A may use its corresponding TCP session (e.g., in-band communications) to instruct UE device 10′ to reduce data transfer for target nQoS data 28A. For example, target application 54A may instruct UE device 10′ to stop transmitting video data while continuing to transmit audio data in target nQoS data 28A. Since target application 54A does not display the video data while operating in the background, this may help to ensure that UE device 10 is able to continue to receive the audio data with satisfactory quality and/or other non-target nQoS data 28B without deteriorating user experience.

At operation 156, UE device 10 receives a user input (e.g., a touch input provided to a touch screen on UE device 10) or a software trigger that causes the operating system of UE device 10 to move target application 54A from the background back to the foreground.

At operation 158, target application 54A may use its corresponding TCP session (e.g., in-band communications) to instruct UE device 10′ to increase data transfer for target nQoS data 28A. For example, target application 54A may instruct UE device 10′ to resume transmitting video data while continuing to transmit audio data in target nQoS data 28A.

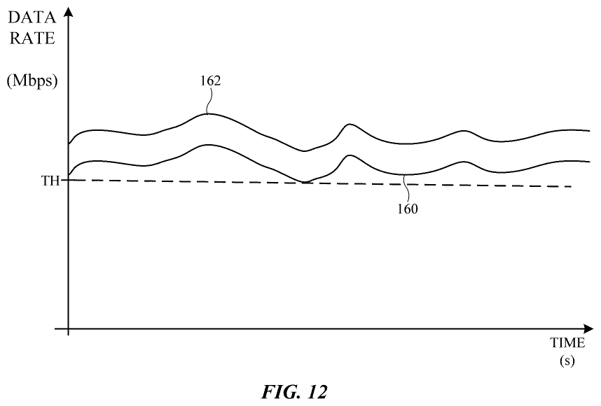

FIG. 12 is a plot of data rate as a function of time showing how the mitigation operations of operation 100 (FIG. 7) serve to boost the data rate of target nQoS data 28A. Curve 162 plots the data rate of a given stream of non-target nQoS data 28B. Curve 160 plots the data rate of target nQoS data 28A. As shown by curve 160, the mitigation operations performed by UE device 10 serve to boost the data rate of target nQoS data 28A above threshold TH, even when UE device 10 concurrently receives the stream of non-target nQoS data 28B. This allows the user to continue to use target application 54A without any noticeable detriment to performance when UE device 10 concurrently receives the stream of non-target nQoS data 28B.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

As described above, one aspect of the present technology is the gathering and use of information such as user input, application data, and/or sensor information. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, eyeglasses prescription, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE, satellite, gateway, core network, base station, network element, etc. as described above in connection with one or more of the preceding figures may be configured to operate in accordance with one or more of the examples set forth herein.

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

The foregoing is merely illustrative and various modifications can be made to the described embodiments. The foregoing embodiments may be implemented individually or in any combination.

What is claimed is:

1. A method of operating an electronic device to communicate with at least a first external device and a second external device via a base station of a cellular network, the method comprising:
executing, using processing circuitry, a first software application and a second software application that is less latency-sensitive than the first software application;
conveying, using one or more antennas, a first stream of wireless data with the first external device via the base station, the first stream of wireless data being associated with the first software application;
receiving, using the one or more antennas, a second stream of wireless data from the second external device via the base station, the second stream of wireless data being associated with the second software application; and
adjusting, using the processing circuitry, receipt of the second stream of wireless data responsive to a data rate of the first stream of wireless data being less than a threshold value.

2. The method of claim 1, wherein adjusting receipt of the second stream of wireless data comprises ending a Transmission Control Protocol (TCP) session between the electronic device and the second external device.

3. The method of claim 2, wherein ending the TCP session comprises transmitting a TCP BYE message to the second external device via the base station, the method further comprising:
continuing to receive, using the one or more antennas, the first stream of wireless data after transmitting the TCP BYE packet to the second external device;
receiving, using the one or more antennas, a TCP synchronization (SYN) message from the second external device via the base station after transmission of the TCP BYE message; and
responsive to receipt of the TCP SYN message from the second device, determining not to respond to the TCP SYN message received from the second external device.

4. The method of claim 1, wherein adjusting receipt of the second stream of wireless data comprises transmitting, to the second external device via the base station, a triple duplicate acknowledgement (TDA) to a packet of the second stream of wireless data.

5. The method of claim 1, wherein adjusting receipt of the second stream of wireless data comprises delaying transmission of an acknowledgment (ACK) to a packet in the second stream of wireless data beyond a scheduled transmission time for the ACK to the packet.

6. The method of claim 1, further comprising:
receiving, from a cloud region using the one or more antennas, a statistical data rate associated with historical usage of the first software application in a cell of the base station, wherein adjusting receipt of the second stream of wireless data comprises adjusting receipt of the second stream of wireless data responsive to a lower of the statistical data rate and a theoretical data rate of the first stream of wireless data being less than the threshold value.

7. The method of claim 1, wherein the first stream of wireless data comprises video data and audio data, the method further comprising:
executing, using the processing circuitry, an operating system of the electronic device; and
transmitting, to the first external device using the one or more antennas, a request to stop transmission of the video data responsive to execution of the first software application moving from a foreground to a background of the operating system.

8. The electronic device of claim 1, wherein the electronic device has a first display with a first resolution, the first external device has a second display with a second resolution greater than the first resolution, the first stream of wireless data comprises video data, and the method further comprises:
transmitting, to the first external device using the one or more antennas, a request to reduce a resolution of the video data.

9. An electronic device configured to communicate via a wireless network, the electronic device comprising:
processing circuitry configured to execute a first software application and a second software application;
one or more antennas; and
a radio communicably coupled to the one or more antennas and configured to
convey, using the one or more antennas, a first stream of wireless data for the first software application over a first transmission control protocol (TCP) session,
receive, using the one or more antennas, a second stream of wireless data for the second software application over a second TCP session, and
transmit, using the one or more antennas, a triple duplicate acknowledgement (TDA) to a packet of the second stream of wireless data based on a data rate of the first wireless data.

10. The electronic device of claim 9, wherein the radio is configured to transmit the TDA to the packet of the second stream of wireless data responsive to the data rate of the first wireless data being below a threshold value.

11. The electronic device of claim 10, wherein the radio is configured to adjust a transmission rate of the TDA based on the data rate of the first wireless data.

12. The electronic device of claim 11, wherein the radio is configured to increment the transmission rate of the TDA while the data rate is less than the threshold value.

13. The electronic device of claim 12, wherein the radio is configured to transmit a TCP BYE message in the second TCP session responsive to the data rate failing to exceed the threshold value after the transmission rate of the TDA has been incremented.

14. The electronic device of claim 9, wherein the first TCP session comprises a first non-quality-of-service (QoS) TCP session and the second TCP session comprises a second non-QoS TCP session.

15. The electronic device of claim 9, wherein the packet of the second stream of wireless data identifies a sequence number of the packet in the second stream of wireless data, the TDA comprising information identifying the sequence number of the packet in the second stream of wireless data.

16. A method of operating an electronic device to communicate with at least a first external device and a second external device via a cellular network, the method comprising:
conveying, using a radio, a first stream of wireless data with the first external device in a first transmission control protocol (TCP) session;
receiving, using the radio, a second stream of wireless data from the second external device in a second TCP session; and
when a performance metric of the first stream of wireless data is outside a predetermined range, delaying transmission of a TCP acknowledgment (ACK) packet in the second TCP session beyond a scheduled transmission time of the TCP ACK packet.

17. The method of claim 16, wherein the performance metric comprises a data rate of the first stream of wireless data and delaying transmission of the TCP ACK packet comprises delaying transmission of the TCP ACK packet when the data rate is less than a threshold value.

18. The method of claim 16, wherein the performance metric comprises an inter-packet arrival time of the first stream of wireless data and delaying transmission of the TCP ACK packet comprises delaying transmission of the TCP ACK packet when an absolute value of the inter-packet arrival time exceeds a threshold value.

19. The method of claim 16, wherein the performance metric comprises a round-trip time (RTT) of the first stream of wireless data and delaying transmission of the TCP ACK packet comprises delaying transmission of the TCP ACK packet when the RTT exceeds a threshold value.

20. The method of claim 16, wherein the first stream of wireless data comprises video data, the performance metric comprises a stall percentage of the video data, and delaying transmission of the TCP ACK packet comprises delaying transmission of the TCP ACK packet when the stall percentage exceeds a threshold value.
